(19) United States
(12) Patent Application Publication
(10) Pub. No.: US 2009/0281897 A1
(43) Pub. Date: Nov. 12, 2009

(54) Capture and Storage of Broadcast Information for Enhanced Retrieval

(76) Inventor: Jeffrey D. Antos, Scituate, MA (US)

Correspondence Address: Richard L. Sampson;SAMPSON & ASSOCIATES, P.C., 50 Congress Street, Boston, MA, 02109, US

(21) Appl. No.: 12/436,672

(22) Filed: May 6, 2009

Related U.S. Application Data
(60) Provisional application No. 61/051,073, filed on May 7, 2008.
(60) Provisional application No. 61/061,197, filed on Jun. 13, 2008.

(51) Int. Cl. G06Q 30/00; G06F 17/30; H04N 7/173

(52) U.S. Cl. 705/14.45; 705/14.54; 707/9; 707/3; 725/131; 707/E17.014

(57) ABSTRACT

A system and method is provided for enhancing retrieval of advertising content transmitted by radio and television broadcasters, includes a broadcast receiver to receive radio and television broadcasts from a plurality of distinct broadcasters, and to generate audio output corresponding thereto. A voice recognition module electronically captures and transcribes audio portions of the broadcasts, and a parsing module electronically parses the transcribed portions of the broadcasts to identify advertising content for various products and services embedded within the broadcasts, and to generate content descriptors. A content descriptor module captures the content descriptors generated by the parsing module and populates a database with the content descriptors. A website server hosts a website which enables a user to search the database by logging onto the site and inputting at least one of the content descriptors. A search response is generated which includes hyperlinks to URLs associated with the advertising content.

### RELATED APPLICATION

This application claims the benefit of U.S. Provisional Applications Ser. No. 61/051073, entitled Adjogger.com, filed on May 7, 2008, and Ser. No. 61/061197, filed on Jun. 13, 2008, entitled Adjogger.com, the contents of both being incorporated herein by reference in their entireties for all purposes.

### BACKGROUND

1. Technical Field

This invention relates to the capture and storage of radio and television broadcast information for enhanced retrieval by users, and more particularly, to a system configured for enhanced retrieval of advertisements heard or viewed while driving or while otherwise distracted.

2. Background Information

Throughout this application, various publications, patents and published patent applications are referred to by an identifying citation. The disclosures of the publications, patents and published patent applications referenced in this application are hereby incorporated by reference into the present disclosure.

In modern day, we are constantly bombarded with information designed to enrich and enhance our lives. One aspect of this information is derived from radio broadcasts which we may be exposed to at various times over the course of any given day—i.e. while driving in our automobiles to and from work or while listening to the radio at the office. More particularly, we are inundated with music/songs, commercial advertisements, news, weather, public service announcements and other material information over very short periods of time as we listen to radio broadcasts throughout our day.

Many times, a user may be exposed to an advertisement for a particular product or service in which he or she has an interest. Unfortunately, the user may catch only a portion of the broadcast and may be unable to identify the specific content to which he or she has just been exposed.

A similar phenomenon occurs when users watch television. While watchers of television content may not be distracted by tasks such as driving, their attention to advertisements is often hampered by the prevalent use of recording devices such as Digital Video Recorders (DVRs) which users routinely use to fast-forward through advertisements. These users therefore typically see only fleeting views of the advertisements. Moreover, it has been well documented that even those viewers who pay close attention to advertisements, such as relatively large budget advertisements placed during premier events such as the Super Bowl, have difficulty remembering such basic things as the sponsor of the advertisement or the advertised goods/services.

Currently, there exists technology for encoding/embedding inaudible identifying information into a radio broadcast signal at the transmit side and for then extracting this encoded/embedded inaudible information at the receiver end as the broadcast is playing. For example, modern radio receivers in most recent automobiles include advanced receivers for receiving and recognizing any digital information encoded/embedded into a radio broadcast, such as a station identifier—e.g., the station name and/or call letters of the station, a song identifier which includes the title of the song, and even an artist identifier which identifies the particular artist performing the song. This information is typically received and displayed at the user end, in real time, as the broadcast is received. As the program content changes, the inaudible embedded information included within the broadcast signal also changes and the displayed information is updated accordingly.

A drawback of this technology is that it tends not to include information related to advertisements inserted between songs or other content. This technology also is not helpful in assisting a user in later identifying previously heard content. More specifically, unless the user has a piece of paper and a pen readily at hand with which to record/note the identifying information as it is received and reproduced, the information is lost as the program continues to play. In particular, if the user is travelling, e.g., driving an automobile, it is doubtful he or she will have time to note the identifying information at the exact time it is displayed and unless such user has a photographic memory, it is doubtful he or she will later be able to recall the identifying information with a high degree of accuracy. Moreover, attempting to take notes of particular content while operating a motor vehicle may be distracting to the driver and thus potentially dangerous.

An additional limitation to this technology is that it is not present in older automobile radios or in most portable radios currently in use, such as older hand held radios or AM/FM alarm clock radios. Accordingly, unless a user is prepared to give up his or her current radio device for a costly upgrade, or to otherwise purchase new hardware, such technology is not available.

A need therefore exists for a system and method which enhances the user's ability to retrieve advertising content of interest, without having to purchase new technology such as upgraded automobile radios and the like. Moreover, it is desirable to enable this functionality without distracting the user or otherwise requiring a user to take any affirmative action when initially observing the content of interest. Still further, a need exists for a system and method for quantifying the efficacy of on-air radio and television advertising.

### SUMMARY

According to one aspect of the invention, a system is provided for enhancing retrieval of advertising content transmitted by radio and television broadcasters, and of monitoring impact of such advertising content. The system includes a broadcast receiver configured to receive radio and television broadcasts from a plurality of distinct broadcasters, and generate audio output corresponding thereto. The broadcast receiver includes a voice recognition module configured to electronically capture and transcribe audio portions of the broadcasts. The broadcast receiver includes a parsing module communicably coupled to the voice recognition module. The parsing module is configured to electronically parse the transcribed portions of the broadcasts to identify advertising content for various products and services, and to generate content descriptors therefor. The content descriptors may include names of the broadcasters, call signs of the broadcasters; times of day in which the advertising content was broadcast; a subject matter of interest associated with the advertising content; a URL for the advertiser; and combinations thereof. The broadcast receiver may also include a content descriptor module configured to electronically capture the content descriptors generated by the parsing module. A database communicably coupled to the broadcast receiver, is configured for population by the content descriptors. A website server communicably coupled to the database is configured to host a website at a predetermined uniform resource locator (URL). The website is configured to enable a user to search the database by logging onto the website and inputting at least one of the content descriptors, and is also configured to display a graphical user interface including a search query template having a plurality of user-selectable content descriptor categories. The website is configured to display a search response including one or more hyperlinks to URLs associated with the advertising content, to capture click-through statistics for users clicking on the hyperlinks, and to transmit click-through statistics associated with particular advertisements to the broadcaster and/or advertiser.

Another aspect of the invention includes a system for enhancing retrieval of advertising content transmitted by radio and television broadcasters, and of monitoring impact of such advertising content. The system includes a broadcast receiver configured to receive radio and television broadcasts from a plurality of distinct broadcasters, and to generate audio output corresponding thereto. The broadcast receiver includes a voice recognition module configured to electronically capture and transcribe audio portions of the broadcasts, and a parsing module configured to electronically parse the transcribed portions of the broadcasts to identify advertising content for various products and services embedded within the broadcasts, and to generate content descriptors therefor. The broadcast receiver also includes a content descriptor module configured to capture the content descriptors generated by the parsing module and to populate a database with the content descriptors. A website server is configured to host a website at a predetermined uniform resource locator (URL), the website being configured to enable a user to search the database by logging onto the website and inputting at least one of the content descriptors, and to display a search response including one or more hyperlinks to URLs associated with the advertising content.

Yet another aspect of the present invention includes a computer implemented method of enhancing retrieval of advertising content transmitted by radio and television broadcasters, and of monitoring impact of such advertising content. The method includes electronically monitoring, with a broadcast receiver, a plurality of broadcasts from a plurality of broadcast radio and television stations, and electronically capturing and transcribing, with a voice recognition module, audio portions of the broadcasts. A parsing module is used to electronically parse the transcribed portions of the broadcasts to identify advertising content for various products and services embedded within the broadcasts, and to generate content descriptors therefor. A content descriptor module electronically captures the content descriptors and uses them to electronically populate a database. A website server communicably coupled to the database hosts a website at a predetermined uniform resource locator (URL), and enables a user to search the database by logging onto the website and inputting at least one of the content descriptors. The website also provides the user with a search response including one or more hyperlinks to other websites associated with the advertising content.

In still another aspect of the invention, an article of manufacture is provided for enhancing retrieval of advertising content transmitted by radio and television broadcasters, and of monitoring impact of such advertising content. The article of manufacture includes a computer usable medium having a computer readable program code embodied therein for electronically monitoring, with a broadcast receiver, a plurality of broadcasts from a plurality of broadcast radio and television stations, and electronically capturing and transcribing, with a voice recognition module, audio portions of the broadcasts. Computer readable program code is also provided to enable parsing module to electronically parse the transcribed portions of the broadcasts to identify advertising content for various products and services embedded within the broadcasts, and to generate content descriptors therefor. Program code is also provided to electronically capture the content descriptors and use them to electronically populate a database. A website server communicably coupled to the database includes computer readable program code to host a website at a predetermined uniform resource locator (URL), and to enable a user to search the database by logging onto the website and inputting at least one of the content descriptors. The website also includes program code to provide the user with a search response including one or more hyperlinks to other websites associated with the advertising content.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a functional block diagram of an exemplary embodiment of the present invention;

FIG. 2 is a sequential view of screens of a graphical user interface in accordance with the embodiment of FIG. 1;

FIGS. 3-5 are views, on an enlarged scale, of the screens of FIG. 2;

FIG. 6 is a view of a screen of an alternate graphical user interface in accordance with the embodiment of FIG. 1; and

FIG. 7 is a view of a screen display associated with an alternate embodiment of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

As discussed above, listeners and watchers of audio and audio-visual content, such as broadcast on radio and television, often have a difficult time remembering advertisements. Listeners often have their attention directed elsewhere, to activities such as driving or performing work related tasks, and thus may not be paying full attention to the advertisement being presented. Even in the event attention is being paid to the advertisement, the tasks at hand may prevent one from safely writing down contact information, etc., for the advertiser. Similarly, watchers of television or other audio-visual content often fast-forward through advertisements. These users therefore typically see only fleeting views of the advertisements.

Listeners/viewers thus often cannot remember such things as which station they were listening to or watching, or the advertised products or services. Broadcast radio and television stations are thus losing revenue to on-line advertising channels such as provided by Google® Inc., and Yahoo® Inc.

Briefly described, embodiments of the present invention address the foregoing issues by providing a website (e.g., Adjogger.com) linked to a broadcast receiver configured to automatically capture descriptive aspects (content descriptors) of broadcast advertisements. The broadcast receiver is also linked to a database which is automatically populated with the captured content descriptors.

The actual advertisements may each be provided with a mention of the website URL (e.g., “find us at Adjogger.com”), which includes a search template through which a listener/watcher may enter one or more of the content descriptors to search for the advertisement/advertiser of interest. For example, relevant content descriptors may include: the name/call letters of a radio station; the time of day, e.g. morning drive; and subject matter of the advertisement, e.g. basement waterproofing. The website may then return a link to the advertiser, which the listener may click to be directed to the advertiser's website for additional product/service information.

In particular embodiments, the website monitors traffic to the sponsor's site, to provide statistics to the broadcaster and/or advertiser regarding the efficacy of their advertisements. Embodiments of the present invention thus enable the broadcaster and advertisers to leverage the benefits of conventional radio and television advertising with those of Internet advertising. These embodiments may thus increase the effectiveness of radio and television advertising, while also enabling users to conveniently measure this effectiveness.

As used in this document, the term “computer” is meant to encompass a workstation, personal computer, personal digital assistant (PDA), wireless telephone, or any other suitable computing device including a processor, a computer readable medium such as a disk drive, flash drive, or other media, upon which computer readable program code (including instructions and/or data) may be disposed, and a user interface. The term “embedded computer” is meant to encompass a computer as defined above, configured for a dedicated use, and which lacks a conventional user interface such as a display and keyboard typically associated with workstations, personal computers, etc. Terms such as “module”, and the like are intended to refer to a computer-related entity, either hardware, a combination of hardware and software, software, or software in execution. For example, a module may be, but is not limited to being, a process running on a processor, a processor, an object, an executable, a thread of execution, a program, and a computer. By way of illustration, both an application running on a server and the server can be modules. One or more modules may reside within a process and/or thread of execution and a module may be localized on one computer and/or distributed between two or more computers or control devices. The term ‘real time’ refers to sensing and responding to external events nearly simultaneously (e.g., within minutes or hours) with their occurrence, or sufficiently fast to enable the device to keep up with an external process (for example, sufficiently fast as to avoid losing data generated by the receiving modules).

Aspects of systems and methods embodying the present invention may be programmed in any suitable language and technology, such as, Hypertext Markup Language (HTML), Active ServerPages (ASP) and Javascript. Alternative versions maybe developed using other programming languages including, but not limited to: C++; Visual Basic; Java; VBScript; Jscript; BCMAscript; DHTM1; XML and CGI. Any suitable database technology can be employed, but not limited to: Microsoft Access and IBM AS 400.

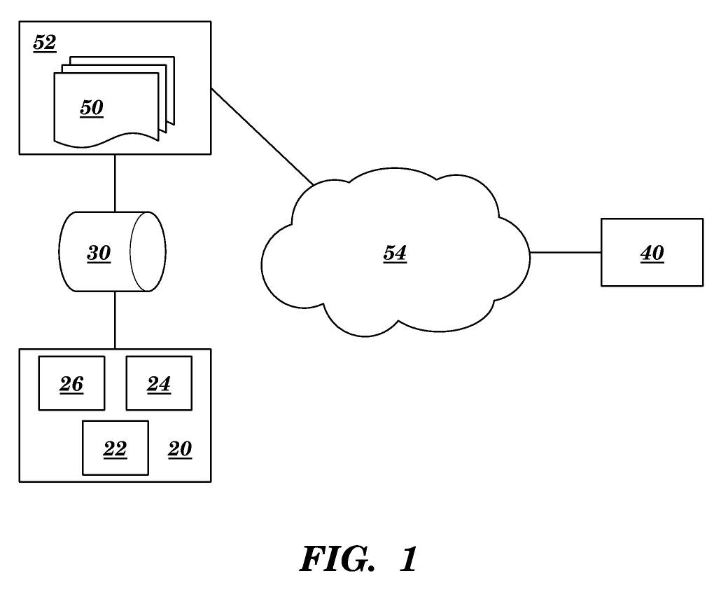

Referring now to the Figures, embodiments of the present invention will be more thoroughly described. Turning now to FIG. 1, in one embodiment of the invention, a system 10 for enhancing retrieval and tracking of advertising content transmitted by radio and television broadcasters, includes a broadcast receiver 20 configured to automatically monitor radio and television broadcasts, identify advertising content embedded into those broadcasts, populate a database 30 with content descriptors associated with the advertising content, and enable the database to be searchable by a user on a client computer 40 via a website 50 hosted by a webserver 52.

In particular representative embodiments, broadcast receiver 20 includes one or more conventional radio or television tuners configured to receive radio and television broadcasts from any one or more of a plurality of distinct broadcasters, i.e., broadcasting stations, either over the air or via cable, and to generate audio output corresponding thereto, such as may be played via loudspeakers, etc. The receiver 20 includes a voice recognition module 22 configured to electronically capture and transcribe audio portions of the received broadcasts. Voice recognition module may include, for example, an embedded computer within receiver 20, running a software application such as Dragon NaturallySpeaking™ 10 Preferred, commercially available from Nuance Communications, Inc. (Burlington, Mass., USA).

Receiver 20 may further include a parsing module 24 communicably coupled to voice recognition module 22. Parsing module 24 is configured to receive and parse the transcribed audio portions generated by voice recognition module 22, to identify advertising content for a plurality of mutually distinct products and services embedded into the broadcasts. Once the advertising has been identified, parsing module 24 may generate content descriptors for each particular identified advertisement. Examples of such content descriptors include the name and/or call sign of the broadcaster (e.g., Oldies 103.3 fm), the time of day in which the advertising content was broadcast, subject matter of interest associated with the advertising content, a URL for the advertiser, and combinations thereof.

In particular embodiments, parsing module 24 may include a embedded computer within receiver 20, running a text analysis software application such as the Rosette® Entity Extractor™ commercially available from Basis Technology Corp. (Cambridge, Mass.), which is capable of entity extraction, information retrieval, text mining, trend analysis and relationship extraction, taxonomy and categorization, data extraction, and concept extraction, etc. The parsing module 24 may thus be configured to scan the transcribed content for the names of specific entities, including names of advertisers, names/call signs of broadcasters, web addresses/URLs of the advertisers, and the subject matter of advertised products and services.

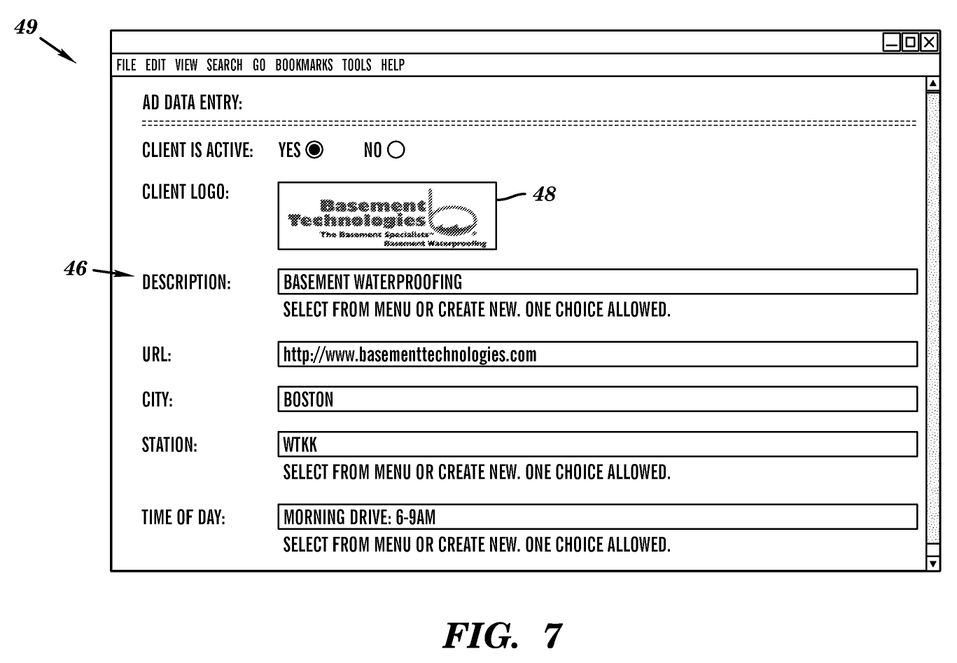

Although text analysis applications such as the Rosette® Entity Extractor™ are capable of relatively sophisticated analysis, various embodiments may be configured for relatively simple analysis, such as to effect key-word searching for occurrences of particular phrases, such as the URL of website 50, which may be inserted by broadcasters into all of their advertisements. In this regard, participating broadcasters may include the URL of website 50, e.g., “find us on adjogger.com”, in order to direct listeners to website 50. The parsing module 24 may thus use this phrase as a tag, and then search for additional descriptors within the nearby content (e.g., within the content occurring within a predetermined number of words immediately preceding or subsequent to the tag). Parsing module 24 may also note the station (broadcaster), city, time of day, week, etc., in which these particular advertisements/descriptors were broadcast. Examples of the advertisement descriptor categories that may be captured by parsing module 24 are shown at 46 in FIG. 7 (discussed hereinbelow).

It should be noted that voice recognition module 22 and parsing module 24 may be run substantially continuously, e.g., at predetermined intervals, so that any changes made by the broadcaster or advertiser, such as changes in the lineup of advertisements being broadcast, changes to the advertising content, and changes to the broadcast times, etc., may be captured substantially in real-time. These updated descriptors may thus be used to update the data in database 30 substantially in real-time, as discussed below.

A content descriptor module 26, communicably coupled to both the parsing module 24 and database 30, and which may also take the form of an embedded computer or processor within receiver 20, may capture the content descriptors generated/obtained by the parsing module. Content descriptor module 26 may also capture additional or expanded content descriptors which may be based upon the descriptors obtained by parsing module 24. For example, descriptor module 26 may be configured to automatically access the websites identified by URLs captured by parsing module 24, either by its own connection to the Internet 54, or by tunneling through database and/or web server 30, 52. Descriptor module 26 may then automatically capture any logos, such as shown at 48 (FIG. 7) associated with any of the other descriptors related to a particular advertisement. The content descriptor module 26 may then populate database 30 with the captured content descriptors, including any logos or other additional/expanded content.

Referring to FIG. 7, although embodiments of the present invention are configured to automatically identify and capture content descriptors for advertising content, it should be noted that advertising content descriptors may also be entered manually via website 50. For example, website 50 may be configured to display a data entry screen 49 which may be used to supplement and/or verify the descriptors captured automatically by parsing module 24. In this regard, various descriptor category fields 46 may be populated with descriptors captured and loaded into database 30 for a particular advertisement by parsing module 24 as shown. Descriptors for any missing fields may then be entered manually. Users, such as may be associated with the advertisers, broadcasters, or operators of embodiments of the present invention, may be provided with password protected access to the website 50 in order to gain access to screen 49 (and database 30).

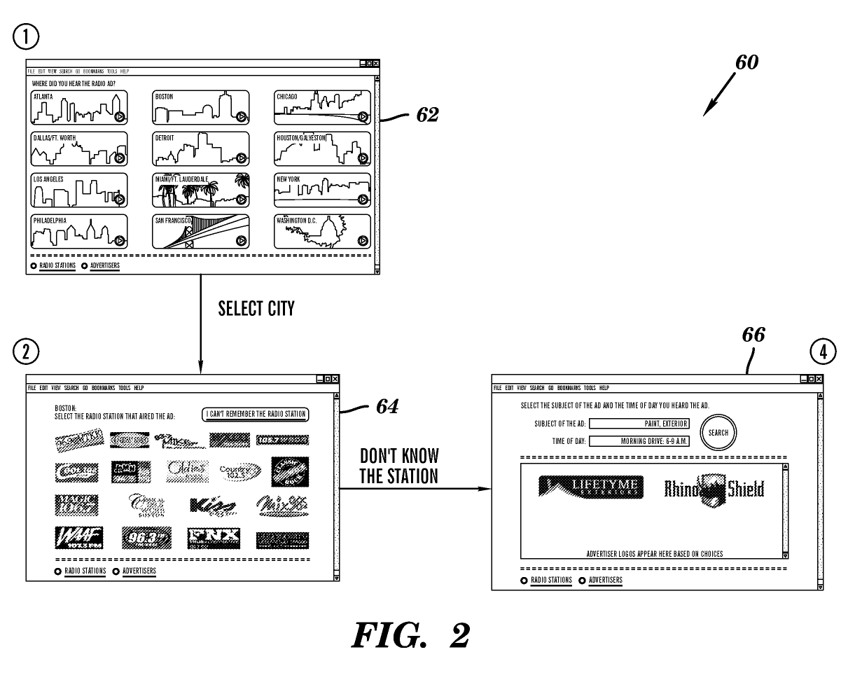

Referring back to FIG. 1, as also shown, database 30 is communicably coupled to the web server 52 hosting website 50. Website 50 is configured in a substantially conventional manner to enable a user, e.g., via substantially any client computer 40, to search the database by logging onto the website, e.g., via the Internet or other network 54, and inputting at least one of the content descriptors. Moreover, in particular embodiments, website 50 is configured to display a graphical user interface 60 (FIG. 2, discussed in greater detail hereinbelow) which includes a graphical search query template which displays a plurality of user-selectable content descriptor categories. In this manner, website 50 facilitates the user's search of database 30.

The website 50 is further configured to display a search response which includes one or more hyperlinks to URLs associated with the advertising content. The website 50 may also include provisions for capturing click-through statistics for users clicking on the hyperlinks, in a manner that would be familiar to those skilled in the art. These click-through statistics may also include the particular content descriptors identified by the users, which ultimately resulted in the click-throughs. The website may then electrically transmit these click-through statistics to the broadcaster and/or advertisers associated with the particular advertisements.

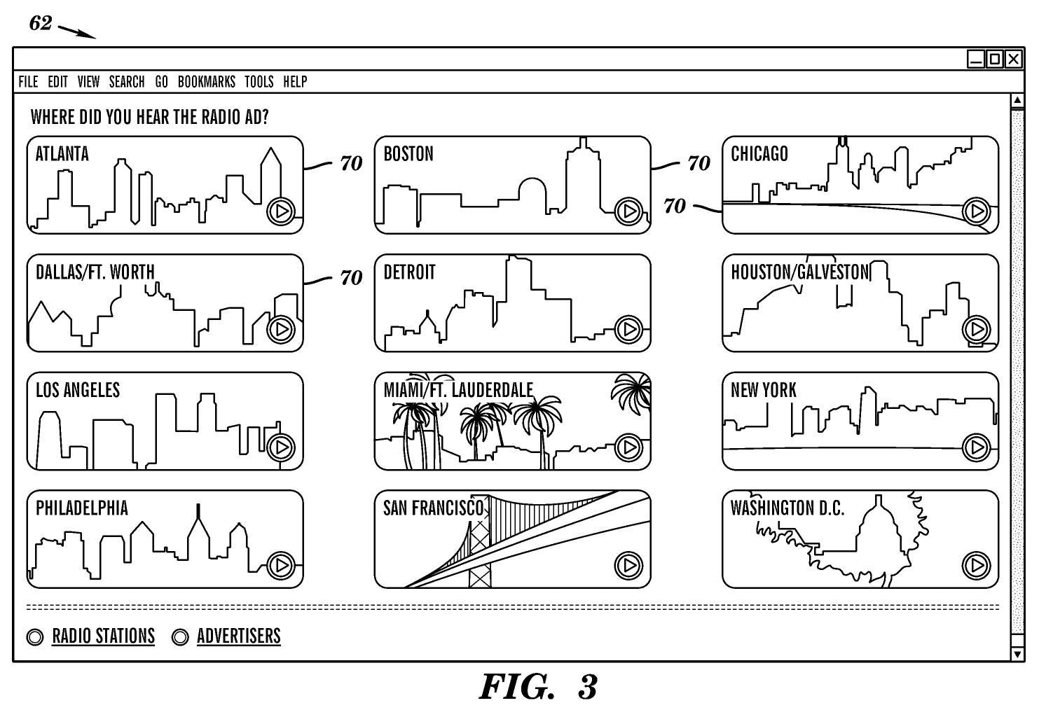

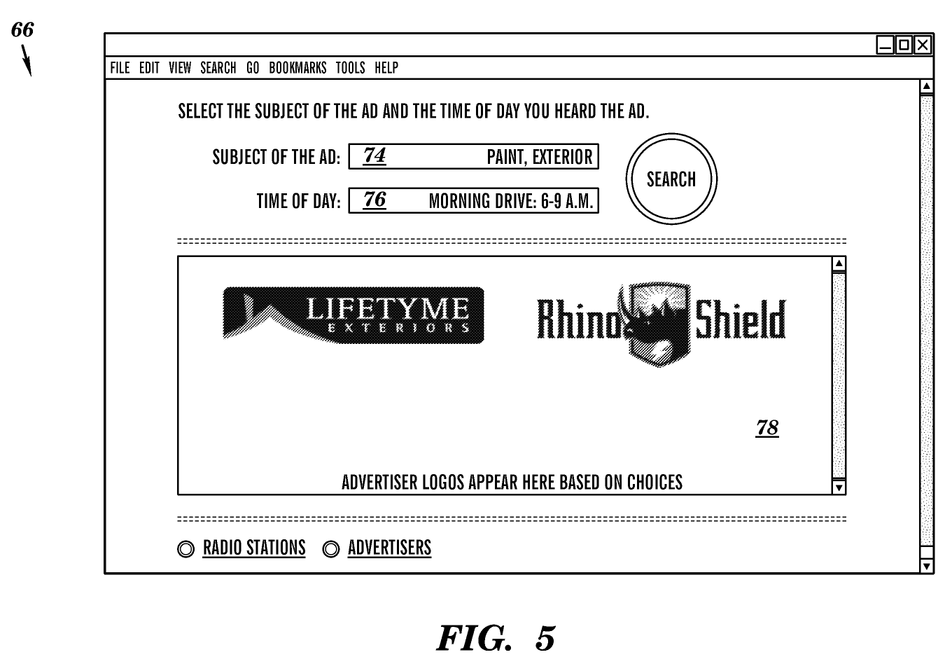

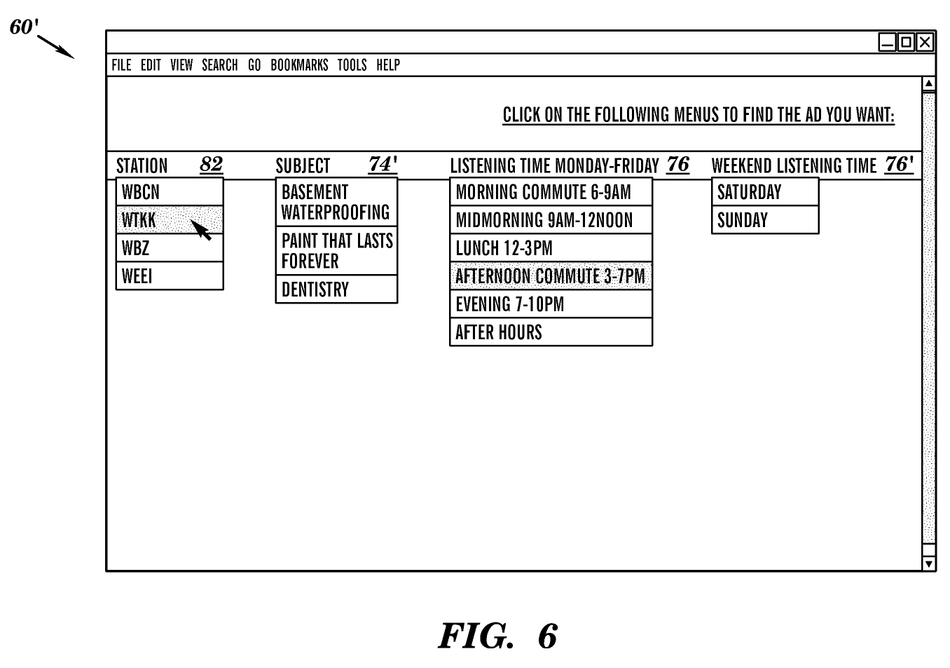

Referring to FIGS. 2-7, aspects of particular embodiments of the present invention will be described in greater detail. Turning now to FIG. 2, an exemplary embodiment of a graphical user interface 60 displayed on website 50 (FIG. 1), includes a city screen 62, a broadcaster (station) screen 64, and a combined subject, time, and results screen 66. As shown in FIG. 3, upon logging onto website 50, a user may view city screen 62, which includes a listing of city icons 70 which may be selected by the user. Once a city is selected, the website may return station screen 64, which may include a listing of station icons 72, e.g., including logos, for the various broadcasting stations in the selected city. Each of the station icons 72 are actuatable by the user. Once one of the station icons are selected in a conventional manner, e.g., by clicking with a mouse or actuating a touch screen, the website 50 may return a subject, time, and results screen 66. Referring now to FIG. 5, an exemplary screen 66 includes content descriptor category fields such as a subject field 74, a time field 76 and a results field 78. The subject and time fields 74, 76 may include pull-down menus such as shown in FIG. 6. Search results, such as advertiser icons, e.g., in the form of advertiser's logos configured as links to their websites, may be displayed in results field 78 once the user actuates the search button 80. In addition, or in the alternative, results may be displayed in field 78 dynamically, i.e., as the user makes the aforementioned selections in fields 74, 76.

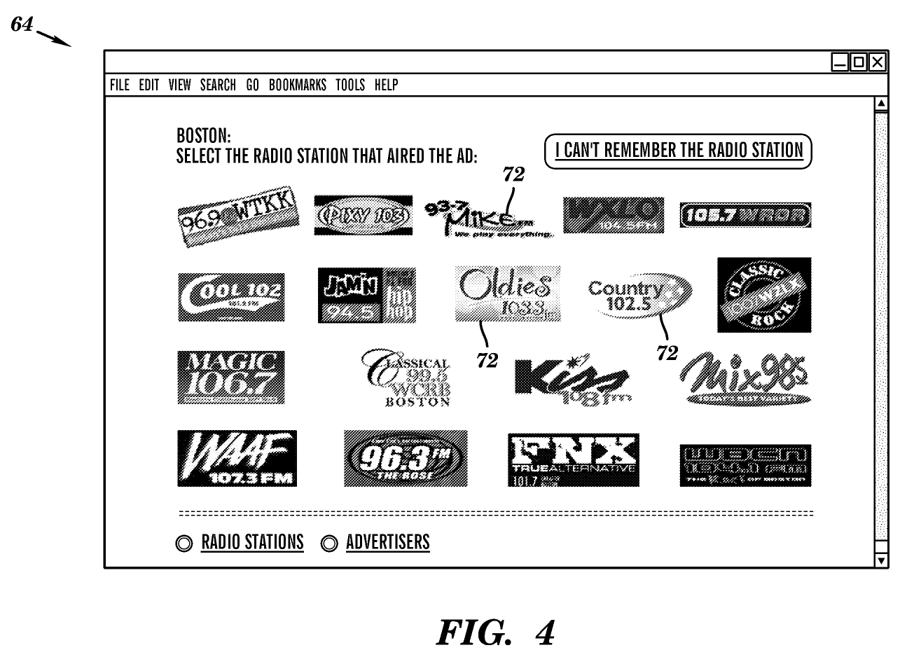

As described above, results screen 66 (FIG. 5) is displayed after the user selects a particular broadcaster 72 on broadcaster screen 64 (FIG. 4). Accordingly, the search results shown in results field 78 of screen 66 (FIG. 5) are for advertisers whose advertisements have been broadcast by the particular selected broadcast station. Similarly, as an optional aspect of these embodiments, an icon/link to website 50 (e.g., to Adjogger.com) may be placed on the broadcaster's website. Upon actuation by the user, the website 50 identifies the source of the click-through (i.e., the IP address of the particular broadcaster's website), and then brings a user directly to a screen 66 (FIG. 5), in which results field 78 is populated with all of that particular station's advertisers. A user may then search among these advertisers by making selections using fields 74 and 76 as described above.

Turning now to FIG. 6, an alternate embodiment of the present invention includes a graphical user interface 60′, which includes a series of descriptor category fields, e.g., station 82, subject 74′, listening time Monday-Friday 76′, and weekend listening time 76″. A user may actuate any of these fields to display pull-down menus with specific advertisement descriptors which may be selected by the user. For example, as shown, the user has selected “Afternoon Commute 3-7 pm” under time field 76′, and “WTKK” under station field 82.

Having disclosed various embodiments of the subject invention, exemplary methods associated with the operation and use thereof will now be described in connection with the following Table I.

In one exemplary embodiment, a computer implemented method is provided for enhancing recall of advertising content transmitted by radio and television broadcasters, and of monitoring impact of such advertising content. The method includes disposing 80 a website at a predetermined uniform resource locator (URL). A receiver module 20 automatically monitors 82, broadcasts from a plurality of broadcast radio and television stations, and identifies 84 advertisements inserted into the monitored broadcasts. Module 20 also identifies and captures 85 advertising content descriptors from the advertisements. Optionally, the content descriptors are selected 86 from the group consisting of: name of the broadcaster; call sign of the broadcaster; time of day in which the advertising content was broadcast; a subject matter of interest associated with the advertising content; and combinations thereof.

The method also includes providing 88 a database on a database server linked to the website, and populating 90 the database with the captured content descriptors. Optionally, content descriptors may be entered manually at 92. At 94, a user is enabled to search the database by logging onto the website associated with the database and inputting at least one of the content descriptors. At the website, a graphical user interface is displayed 96, which includes a graphical search query template having a plurality of user-selectable content descriptor categories. A search response is provided 98, which includes one or more hyperlinks to the advertisers' websites. Optionally, click-through statistics may be captured 100 for users clicking on the hyperlinks, such statistics including the particular content descriptors identified by the users prior to clicking on the hyperlinks. As a further option, the click-through statistics may be electrically transmitted 102 to one or more of the particular broadcaster and advertiser.

TABLE I

| | |
|---|---|
| 80 | disposing a website at a URL; |
| 82 | automatically monitoring broadcasts; |
| 84 | with a receiver module, automatically identifying advertisements inserted into the |
| | monitored broadcasts; |
| 85 | with the receiver module, automatically identifying and capturing advertising content |
| | descriptors from the advertisements, |
| 86 | Optionally, select content descriptors from among group of: name of the |
| | broadcaster; call sign of the broadcaster; time of day in which the advertising content |
| | was broadcast; subject matter of advertising content; and combinations thereof; |
| 88 | providing a database on database server linked tothe website; |
| 90 | populating the database with the captured content descriptors; |
| 92 | Optionally, entering content descriptors manually; |
| 94 | enabling a user to search the database by logging onto the website and inputting |
| | content descriptor; |
| 96 | Optionally, displaying graphical user interface including search query template; |
| 98 | providing search response including one or more hyperlinks to advertiser's website; |
| 100 | Optionally, capturing click-through statistics, including content descriptors |
| | identified by the users prior to clicking on the hyperlinks; |
| 102 | Optionally, transmitting click-through statistics associated with particular |
| | advertisements broadcaster and/or advertiser. |

Additional optional aspects of the foregoing method are shown in Table II. At 104, the displaying 96 includes providing the graphical user interface with a hierarchical display of predetermined categories of content descriptors. At 106, the broadcasters and/or advertisers are instructed to insert the URL of the website into their advertisements. At 108, the content descriptors are selected from the group of: a product or service associated with the advertising content; a title or name of a particular advertised product or service; a title of a broadcast in which the web site address may have been advertised; a name of a city or town where the broadcast may have been received; a day, week, month or year which the advertising content was broadcast; and a name of a host, celebrity or personality associated with the advertisement content, the broadcaster, or the broadcast; and combinations thereof. At 110, access to the database is password protected.

TABLE II

| | |
|---|---|
| 104 | displaying includes providing the graphical user interface with |
| | a hierarchical display of predetermined |
| | categories of content descriptors |
| 106 | Instructing broadcasters/advertisers to insert the |
| | URL of the website into their advertisements |
| 108 | Selecting content descriptors from among product |
| | or service; title or name of a product or service; |
| | title of a broadcast; name of a city or town; |
| | a day, week, month or year; and name of a host, |
| | celebrity or personality; and combinations thereof |
| 110 | password protecting database |

Furthermore, as discussed above, aspects of the various embodiments of the present invention may include a computer program code-based product, which includes a computer readable storage medium having program code stored therein which can be used to instruct a computer to perform any of the functions, methods and/or modules associated with the present invention. The computer storage medium may include any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be further noted that the various modules and other components of the embodiments discussed hereinabove may be configured as hardware, as computer readable code stored in any suitable computer usable medium, such as ROM, RAM, flash memory, phase-change memory, magnetic disks, etc., and/or as combinations thereof, without departing from the scope of the present invention.

The above systems may be implemented in various computing environments. For example, aspects of the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

It should be understood that any of the features described with respect to one of the embodiments described herein may be similarly applied to any of the other embodiments described herein without departing from the scope of the present invention. Moreover, although modules 22, 24 and 26 have been shown and described as being embedded within receiver 20, it should be recognized that one or more of these modules may be disposed outside of receiver 20, e.g., in a distributed processor arrangement, without departing from the spirit and scope of the present invention. Similarly, one or more of these modules may combined into a common embedded computer without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having thus described the invention, what is claimed is:

1. A system for enhancing retrieval of advertising content transmitted by radio and television broadcasters, and of monitoring impact of such advertising content, the system comprising:
a broadcast receiver configured to receive radio and television broadcasts from a plurality of distinct broadcasters, and generate audio output corresponding thereto;
said broadcast receiver including a voice recognition module configured to electronically capture and transcribe audio portions of the broadcasts;
said broadcast receiver including a parsing module communicably coupled to said voice recognition module, said parsing module configured to electronically parse the transcribed portions of the broadcasts to identify advertising content for a plurality of mutually distinct products and services embedded into the broadcasts, and to generate content descriptors therefor, wherein the content descriptors include a plurality of members of the group consisting of: name of the broadcaster; call sign of the broadcaster; time of day in which the advertising content was broadcast; a subject matter of interest associated with the advertising content; a URL for the advertiser; and combinations thereof;
said broadcast receiver further including a content descriptor module configured to electronically capture the content descriptors generated by said parsing module;
a database communicably coupled to said broadcast receiver, configured for population by the content descriptors captured by said content descriptor module;
a website server communicably coupled to said database, and configured to host a website at a predetermined uniform resource locator (URL);
the website configured to enable a user to search the database by logging onto the website and inputting at least one of the content descriptors;
the website configured to display a graphical user interface including a search query template having a plurality of user-selectable content descriptor categories;
the website configured to display a search response including one or more hyperlinks to URLs associated with the advertising content;
the website configured to capture click-through statistics for users clicking on the hyperlinks, including the particular content descriptors identified by the users prior to clicking on the hyperlinks; and
the website configured to electrically transmit click-through statistics associated with particular advertisements to at least one of the broadcaster and advertiser.

2. A system for retrieving advertising content transmitted by radio and television broadcasters, the system comprising:
a broadcast receiver configured to receive radio and television broadcasts from a plurality of distinct broadcasters, and generate audio output corresponding thereto;
said broadcast receiver including a voice recognition module configured to electronically capture and transcribe audio portions of the broadcasts;
said broadcast receiver including a parsing module communicably coupled to said voice recognition module, said parsing module configured to electronically parse the transcribed portions of the broadcasts to identify advertising content for a plurality of mutually distinct products and services embedded into the broadcasts, and to generate content descriptors therefor;
said broadcast receiver further including a content descriptor module configured to capture the content descriptors generated by said parsing module;
a database communicably coupled to said broadcast receiver, configured for population by the content descriptors captured by said content descriptor module;
a website server communicably coupled to said database, and configured to host a website at a predetermined uniform resource locator (URL);
the website configured to enable a user to search the database by logging onto the website and inputting at least one of the content descriptors; and
the website configured to display a search response including one or more hyperlinks to URLs associated with the advertising content.

3. The system of claim 2, wherein the parsing module is configured to identify advertising content by the predetermined URL inserted into the advertisements.

4. The system of claim 2, wherein the website is configured to enable population of the database by manually entered content descriptors.

5. The system of claim 4, wherein access to the database is protected by a password.

6. The system of claim 2, wherein said parsing module is configured to capture content descriptors from among the group of: name of the broadcaster; call sign of the broadcaster; IP address of the broadcaster; time of day in which the advertising content was broadcast; a subject matter of interest associated with the advertising content; a URL for the advertiser; and combinations thereof.

7. The system of claim 6, wherein said content descriptor module is configured to generate expanded content descriptors, including logos associated with the advertising content, using the content descriptors generated by said parsing module.

8. The system of claim 6, wherein said parsing module is configured to capture content descriptors from among the group of: a product or service associated with the advertising content; a name of a particular advertised product or service; a title of a broadcast in which the advertising content was inserted; a name of a city or town where the broadcast may have been received; a day, week, month or year in which the advertising content was broadcast; a name of a host, celebrity or personality associated with the advertisement content, the broadcaster, or the broadcast; and combinations thereof.

9. The system of claim 6, wherein the website is configured to display a graphical user interface including a search query template having a plurality of user-selectable content descriptor categories.

10. The method of claim 9, wherein the graphical user interface is configured to display a hierarchical display of predetermined categories of content descriptors.

11. The system of claim 9, wherein the website is configured to capture click-through statistics for users clicking on the hyperlinks, including the particular content descriptors identified by the users prior to clicking on the hyperlinks.

12. The system of claim 11, wherein the website is configured to electronically transmit click-through statistics associated with particular advertisements to at least one of the broadcaster and advertiser.

13. The system of claim 2, wherein the website is configured to enable a user to search the database by logging onto the website via a hyperlink from a particular broadcaster's website, wherein the at least one of the content descriptors includes an IP address of the particular broadcaster's website; and
the website is configured to display a search response including one or more hyperlinks to URLs associated with the advertising content broadcast by the particular broadcaster.

14. A computer implemented method of retrieving advertising content transmitted by radio and television broadcasters, the method comprising:
(a) electronically monitoring, with a broadcast receiver, a plurality of broadcasts from a plurality of broadcast radio and television stations;
(b) electronically capturing and transcribing, with a voice recognition module, audio portions of the broadcasts;
(c) electronically parsing, with a parsing module, the transcribed portions of the broadcasts to identify advertising content for a plurality of mutually distinct products and services embedded within the broadcasts, and generating content descriptors therefor;
(d) electronically capturing, with a content descriptor module, the content descriptors generated by the parsing module;
(e) electronically populating a database with the captured content descriptors captured by the content descriptor module;
(f) hosting a website at a predetermined uniform resource locator (URL), with a website server communicably coupled to the database;
(g) enabling a user to search the database by logging onto the website and inputting at least one of the content descriptors; and
(h) providing to the user a search response including one or more hyperlinks to other websites associated with the advertising content.

15. The system of claim 14, wherein said electronically parsing (c) comprises identifying advertising content by the predetermined URL inserted into the advertisements.

16. The system of claim 15, further comprising electronically instructing at least one of the broadcasters and advertisers to insert the predetermined URL into the advertisements.

17. The method of claim 14, further comprising enabling population of the database by content descriptors manually entered via the website.

18. The method of claim 17, wherein access to the database is protected by a password.

19. The method of claim 14, wherein said electronically parsing (c) further comprises capturing content descriptors from among the group of: name of the broadcaster; call sign of the broadcaster; IP address of the broadcaster; time of day in which the advertising content was broadcast; a subject matter of interest associated with the advertising content; a URL for the advertiser; and combinations thereof.

20. The method of claim 19, further comprising generating expanded content descriptors, including a logo associated with the advertising content, with the content descriptor module, using the content descriptors generated by the parsing module.

21. The method of claim 19, wherein said electronically parsing (c) further comprises capturing content descriptors from among the group of: a product or service associated with the advertising content; a name of a particular advertised product or service; a title of a broadcast in which the advertising content was inserted; a name of a city or town where the broadcast may have been received; a day, week, month or year in which the advertising content was broadcast; a name of a host, celebrity or personality associated with the advertisement content, the broadcaster, or the broadcast; and combinations thereof.

22. The method of claim 19, wherein said enabling (g) comprises displaying a graphical user interface including a search query template having a plurality of user-selectable content descriptor categories.

23. The method of claim 22, wherein said enabling (g) comprises displaying a graphical user interface including a hierarchical display of predetermined categories of content descriptors.

24. The method of claim 22, further comprising electronically capturing click-through statistics for users clicking on the hyperlinks, including the particular content descriptors identified by the users prior to clicking on the hyperlinks.

25. The method of claim 24, further comprising electronically transmitting click-through statistics associated with particular advertisements to at least one of the broadcaster and advertiser.

26. The system of claim 14, wherein said enabling (g) comprises enabling a user to search the database by logging onto the website via a hyperlink from a particular broadcaster's website, wherein the inputting at least one of the content descriptors includes automatically receiving an IP address of the particular broadcaster's website; and said providing (h) comprises providing to the user a search response including one or more hyperlinks to other websites associated with the advertising content broadcast by the particular broadcaster.

27. An article of manufacture for enhancing retrieval of advertising content transmitted by radio and television broadcasters, and of monitoring impact of such advertising content, the article of manufacture comprising:
a computer usable medium having a computer readable program code embodied therein, said computer usable medium having:
(a) computer readable program code for electronically monitoring, with a broadcast receiver, a plurality of broadcasts from a plurality of broadcast radio and television stations;
(b) computer readable program code for electronically capturing and transcribing, with a voice recognition module, audio portions of the broadcasts;
(c) computer readable program code for electronically parsing, with a parsing module, the transcribed portions of the broadcasts to identify advertising content for a plurality of mutually distinct products and services embedded within the broadcasts, and generating content descriptors therefor;
(d) computer readable program code for electronically capturing, with a content descriptor module, the content descriptors generated by the parsing module;
(e) computer readable program code for electronically populating a database with the captured content descriptors captured by the content descriptor module;
(f) computer readable program code for hosting a website at a predetermined uniform resource locator (URL), with a website server communicably coupled to the database;
(g) computer readable program code for enabling a user to search the database by logging onto the website and inputting at least one of the content descriptors; and
(h) computer readable program code for providing to the user a search response including one or more hyperlinks to other websites associated with the advertising content.
